(19) United States
(12) Patent Application Publication
(10) Pub. No.: US 2007/0035649 A1
(43) Pub. Date: Feb. 15, 2007

(54) Image pixel reset through dual conversion gain gate

(75) Inventor: Jeffrey A. McKee, Meridian, ID (US)

Correspondence Address: DICKSTEIN SHAPIRO LLP, 1825 EYE STREET NW, Washington, DC, 20006-5403, US

(73) Assignee: Micron Technology, Inc.

(21) Appl. No.: 11/200,052

(22) Filed: Aug. 10, 2005

(51) Int. Cl. H04N 5/335

(52) U.S. Cl. 348/308

(57) ABSTRACT

An imager with pixels having dual conversion gain. Each pixel has a dual conversion gain element coupled between two floating diffusion regions. When activated, the dual conversion gain element switches in a storage element to increase the charge storage capacity of the pixel. Pixel reset circuitry is coupled to the second floating diffusion region. In order to reset the first floating diffusion region and the storage element, the dual conversion gain element is activated during the reset operation.

### FIELD OF THE INVENTION

The invention relates generally to imaging devices and more particularly to increasing the fill factor and charge storage capacity of an imaging device and to resetting image pixels.

### BACKGROUND

Typically, a digital imager array includes a focal plane array of pixel cells, each one of the cells including a photosensor, e.g. a photogate, photoconductor, or a photodiode. In a CMOS imager a readout circuit is connected to each pixel cell, which typically includes a source follower output transistor. The photosensor converts photons to electrons, which are typically transferred to a floating diffusion region connected to the gate of the source follower output transistor. A charge transfer device (e.g., transistor) can be included for transferring charge from the photosensor to the floating diffusion region. In addition, such imager pixel cells typically have a transistor for resetting the floating diffusion region to a predetermined charge level prior to charge transference. The output of the source follower transistor is gated as a pixel output signal by a row select transistor.

Exemplary CMOS imaging circuits, processing steps thereof, and detailed descriptions of the functions of various CMOS elements of an imaging circuit are described, for example, in U.S. Pat. No. 6,140,630, U.S. Pat. No. 6,376,868, U.S. Pat. No. 6,310,366, U.S. Pat. No. 6,326,652, U.S. Pat. No. 6,204,524, and U.S. Pat. No. 6,333,205, each assigned to Micron Technology, Inc, which are hereby incorporated by reference in their entirety.

With reference to FIGS. 1 and 2, which respectively illustrate a top-down and a cross-sectional view of a conventional CMOS imager pixel cell 100, when incident light 187 strikes the surface of a photodiode photosensor 120, electron/hole pairs are generated in the p-n junction of the photodiode (represented at the boundary of n- accumulation region 122 and p+surface layer 123). The generated electrons (photo-charges) are collected in the n-type accumulation region 122 of the photodiode 120. The photo-charges move from the initial charge accumulation region 122 to a floating diffusion region 110 via a transfer transistor 106. The charge at the floating diffusion region 110 is typically converted to a pixel output voltage by a source follower transistor 108 and subsequently output on a column output line 111 via a row select transistor 109.

Conventional CMOS imager designs, such as that shown in FIG. 1 for pixel cell 100, provide approximately a fifty percent fill factor, meaning only half of the pixel 100 is utilized in converting light to charge carriers. As shown, only a small portion of the cell 100 comprises a photosensor (photodiode) 120. The remainder of the pixel cell 100 includes isolation regions 102, shown as STI regions in a substrate 101, the floating diffusion region 110 coupled to a transfer gate 106′ of the transfer transistor 106, and source/drain regions 115 for reset 107, source follower 108, and row select 109 transistors having respective gates 107′, 108′, 109′. Moreover, as the total pixel area continues to decrease (due to desired scaling), it becomes increasingly important to create high sensitivity photosensors that utilize a minimum amount of surface area and/or to find more efficient layouts on the pixel array for the non-photosensitive components of the pixel cells to provide increased photosensitive areas.

In addition, conventional storage nodes, such as floating diffusion region 110, have a limited amount of charge storage capacity. Once this capacity is reached, the pixel cell 100 becomes less efficient. Once the charge storage capacity is exceeded, an undesirable phenomenon occurs, whereby the “over-capacity” charges escape to other parts of the pixel cell 100 or to adjacent pixel cells, which is undesirable.

Accordingly, there is a need and desire for an efficient pixel cell array architecture that has an improved fill factor and charge storage capacity.

### SUMMARY

The invention provides an efficient pixel cell array architecture that has an improved fill factor and charge storage capacity.

The above and other features and advantages are achieved in various exemplary embodiments of the invention by providing an imager with pixels having dual conversion gain. Each pixel has a dual conversion gain element coupled between two floating diffusion regions. When activated, the dual conversion gain element switches in a storage element to increase the charge storage capacity of the pixel. Pixel reset circuitry is coupled to the second floating diffusion region. In order to reset the first floating diffusion region and the storage element, the dual conversion gain element is activated during the reset operation.

The invention also provides shared pixel configurations where the dual conversion gain element, storage element and reset and readout components are shared by two or more pixels to increase pixel fill factor in addition to increasing pixel charge storage capacity.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates a conventional CMOS imager pixel cell;

FIG. 2 is a cross-sectional view of the CMOS imager pixel cell illustrated in FIG. 1;

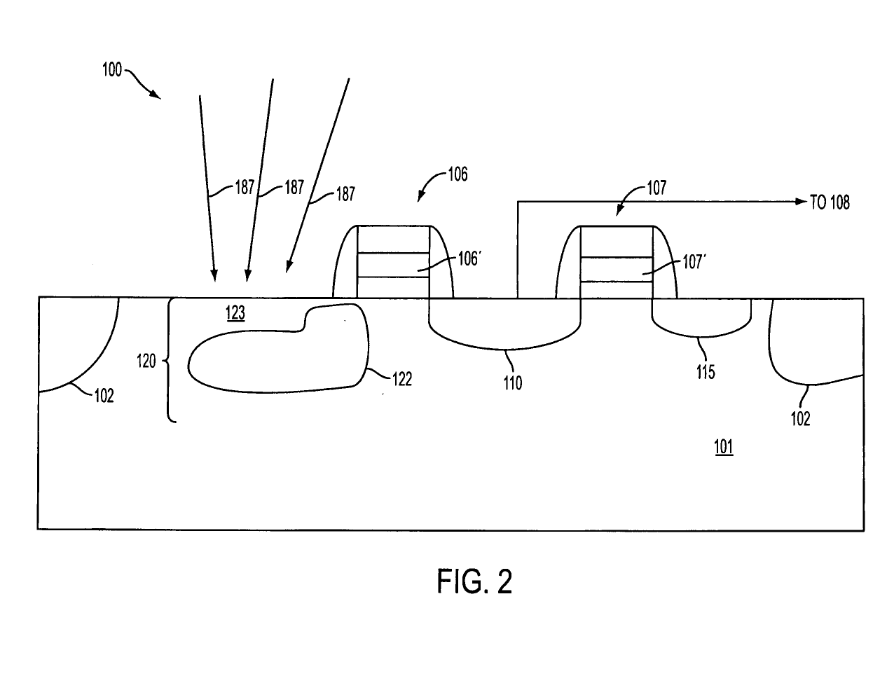

FIG. 3 illustrates an exemplary CMOS imager pixel cell constructed in accordance with an embodiment of the invention;

FIG. 4 is a timing diagram illustrating an exemplary operation of the pixel cell illustrated in FIG. 3;

FIG. 5 illustrates an exemplary four-way shared CMOS imager pixel circuit constructed in accordance with an embodiment of the invention;

FIG. 6 is a timing diagram illustrating an exemplary operation of the pixel circuit illustrated in FIG. 5;

FIG. 7 illustrates an exemplary two-way shared CMOS imager pixel circuit constructed in accordance with an embodiment of the invention;

FIG. 8 shows an imager constructed in accordance with an embodiment of the invention; and

FIG. 9 shows a processor system incorporating at least one imager constructed in accordance with an embodiment of the invention.

### DETAILED DESCRIPTION

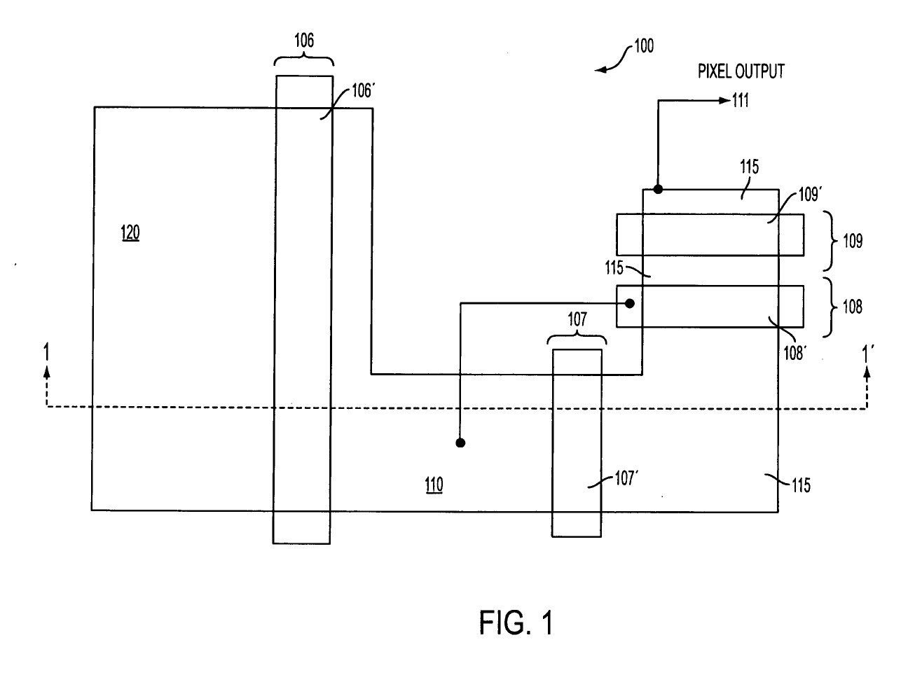

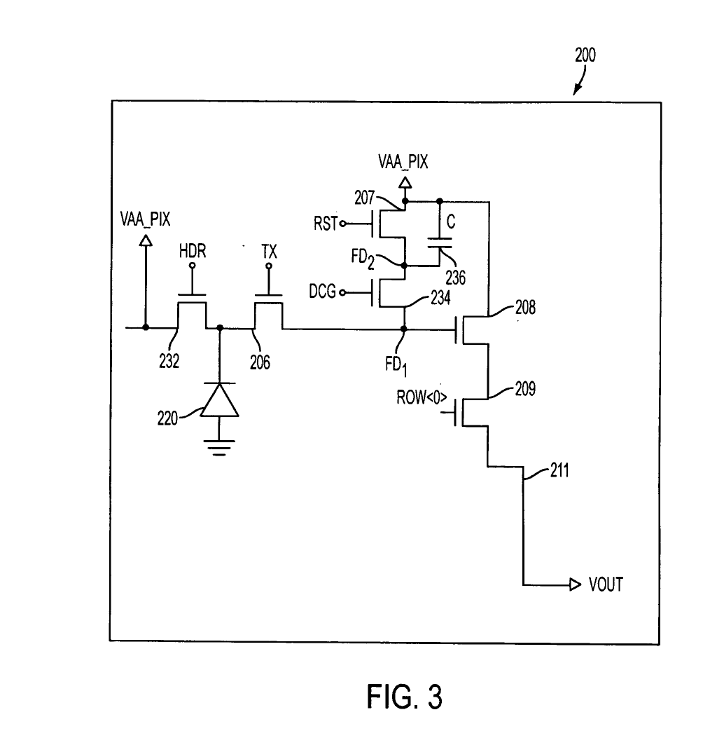

FIG. 3 illustrates an exemplary CMOS imager pixel cell 200 constructed in accordance with an embodiment of the invention. The pixel cell 200 is similar to the conventional pixel cell 100 (FIG. 1) in that the cell 200 includes a photosensor 220 (illustrated as a photodiode), transfer transistor 206, reset transistor 207, source follower transistor 208, row select transistor 209 and a floating diffusion region FD₁. Unlike the conventional pixel cell 100 (FIG. 1), the illustrated cell 200 also includes a dual conversion gain (DCG) transistor 234, capacitor 236, second floating diffusion region FD₂ and a high dynamic range (HDR) transistor 232.

The pixel cell 200 is connected as follows. The HDR transistor 232 (if included within the cell 200) is connected between the photosensor 220 and a pixel supply voltage Vaa-pix. The gate terminal of the HDR transistor 232 is connected to receive a high dynamic range control signal HDR. In operation, when the high dynamic range control signal HDR is generated, the HDR transistor 232 is activated, which allows excess charge to be drained away from the photosensor 220. It should be noted that the HDR transistor 232 is an optional component that is not necessary to practice the invention (as described below). That is, in another embodiment of the pixel cell 200, the HDR transistor 232 is not included.

The transfer transistor 206 is connected between the photosensor 220 and the first floating diffusion region FD₁ and is controllable by a transfer gate control signal TX. When the transfer gate control signal TX is generated, the transfer transistor 206 is activated, which allows charge from the photosensor 220 to flow to the first floating diffusion region FD₁. The gate of the source follower transistor 208 is connected to the first floating diffusion region FD₁. A source/drain terminal of the source follower transistor 208 is connected to the array pixel supply voltage Vaa-pix. The row select transistor 209 is connected between the source follower transistor 208 and a pixel array column line 211.

The reset transistor 207 is connected between the array pixel supply voltage Vaa-pix and the second floating diffusion region FD₂. The capacitor 236 is connected across the reset transistor 207. The DCG transistor 234 is connected between the first floating diffusion region FD₁ and the second floating diffusion region FD₂. The gate terminal of the DCG transistor 234 is connected to a dual conversion gain control signal DCG.

When the dual conversion gain control signal DCG is generated, the DCG transistor 234 is activated, which connects the storage capacitance C of the capacitor 236, and the second floating diffusion region FD₂, to the first floating diffusion region FD₁. This increases the storage capability of the pixel cell 200 beyond the capacity of the first floating diffusion region FD₁, which is desirable and mitigates the leakage problems of the conventional pixel cell 100 (FIG. 1). That is, the pixel 200 contains a first conversion gain based solely on the storage capacity of the first floating diffusion region FD₁, which is beneficial for low light conditions, and a second conversion gain based on the storage capacities of the first floating diffusion region FD₁ and the capacitor 236 (connected at the second floating diffusion region FD₂), which is beneficial for bright light conditions.

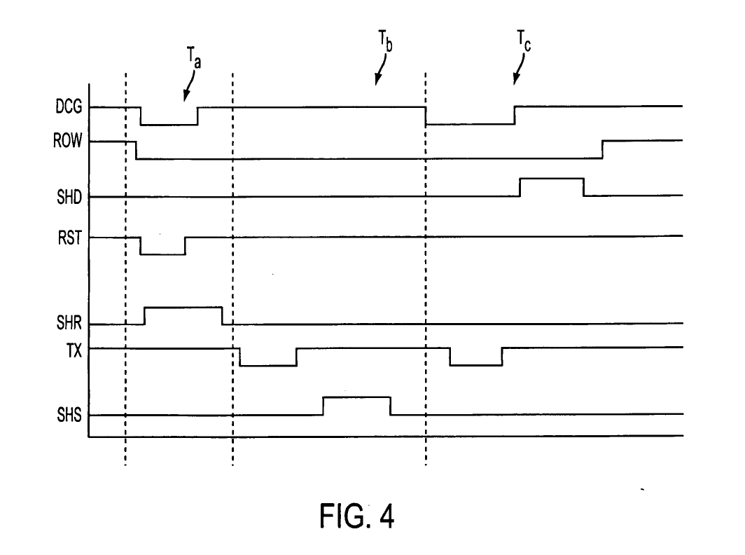

FIG. 4 is a timing diagram illustrating an exemplary operation of the pixel cell 200 illustrated in FIG. 3. The timing diagram illustrates three periods Tₐ, T_{b}, T_{c}. During the first time period Tₐ, the row select signal ROW is applied to the gate of the row select transistor 209 (shown as being active low in FIG. 4). It should be appreciated that FIG. 4 is an example timing diagram and that it is immaterial whether a signal is illustrated as being active low or high in FIG. 4. All that is required to practice the invention is for the illustrated control signal to activate the component the signal is controlling.

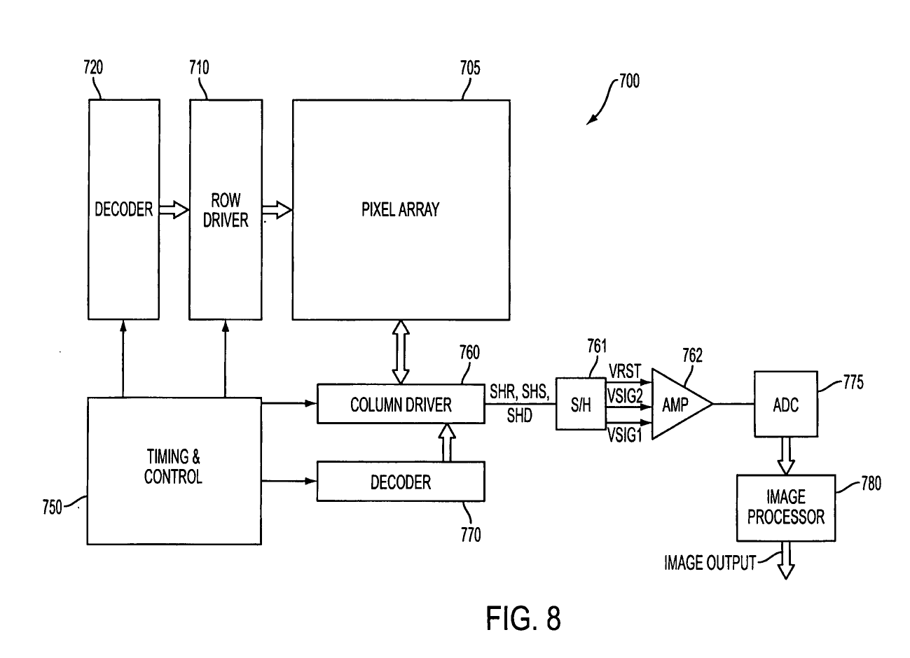

The first floating diffusion region FD₁ of the pixel circuit 200 is reset by asserting the dual conversion gain control signal DCG (shown as being active low in FIG. 4) and the reset control signal RST (shown as being active low in FIG. 4) at the same time. This causes the array pixel supply voltage Vaa-pix to be applied to the first floating diffusion region FD₁ (through the reset and DCG transistors 207, 234). The array pixel supply voltage Vaa-pix is also applied to the second floating diffusion region FD₂ and the capacitor 236. The reset signal voltage Vrst associated with the reset first floating diffusion region FD₁ (as output by the source follower transistor 208 and activated row select transistor 209) is applied to column line 211 and is sampled and held by a sample and hold circuit 761 (FIG. 8) coupled to the column line 211 by the pulsing of a sample and hold reset signal SHR, which activates the sample and hold circuit. The sample and hold circuit 761 is described in greater detail below with reference to FIG. 8.

During the second time period T_{b}, charge accumulating in the photosensor 220 is transferred to the first floating diffusion region FD₁ when the transfer gate control signal TX is asserted (shown as being active low in FIG. 4) and activates the transfer transistor 206. The pixel signal voltage Vsig1 associated with the pixel signal charge stored in the first floating diffusion region FD₁ (as output by the source follower transistor 208 and activated row select transistor 209) is applied to column line 211 and is sampled and held by a sample and hold circuit 761 (FIG. 8) coupled to the column line 211 by the pulsing of a sample and hold pixel signal SHS, which activates the sample and hold circuit.

To increase the charge storage capacity of the pixel cell 200, the following operations are performed during the third time period T_{c}. It should be noted that the following third time period T_{c} operations may be performed for every readout operation or only when needed to avoid the over capacity condition described above (i.e., when a controller or image processor (described below in more detail with respect to FIG. 8) determines that the amount of incident light will result in the first floating diffusion region FD₁ being saturated).

During the third time period T_{c}, the dual conversion gain control signal DCG is applied (shown as being active low in FIG. 4). This causes the DCG transistor 234 to become active, which connects the first floating diffusion region FD₁ to the second floating diffusion region FD₂. The charge within the first floating diffusion region FD₁ is shared with the second floating diffusion region FD₂ and is then stored in the capacitor 226. The transfer gate control signal is applied (shown as being active low in FIG. 4) to activate the transfer transistor 206. The new charged collected in the photosensor 220 is stored in the first floating diffusion region FD₁ and the second floating diffusion region FD₂. The new pixel signal voltage Vsig2 associated with the new pixel signal charge stored in the first floating diffusion region FD₁ and the second floating diffusion region FD₂ (as output by the source follower transistor 208 and activated row select transistor 209) is applied to column line 211 and is sampled and held by a sample and hold circuit 761 (FIG. 8) coupled to the column line 211 by the pulsing of a third sample and hold signal (shown as SHD in FIG. 4), which activates the sample and hold circuit. The three sampled and held signals Vrst, Vsig1, Vsig2 may then undergo a correlated sampling operation to obtain the actual pixel signal level.

It should be noted that if an HDR transistor 232 is used in the pixel circuit 200, then the high dynamic range control signal HDR would be applied throughout all three time periods Tₐ, T_{b}, T_{c} to ensure that the HDR transistor 232 remains active during the readout operations. This prevents blooming and other phenomena from occurring during the readout process.

It should also be noted that another way to operate the pixel 200 circuit is to transfer charge from the photosensor 220 to the first floating diffusion region FD₁ during the second time period T_{b}. Instead of reading out the charge immediately, the charge is allowed to stay, and if there is too much charge, the charge will leak to the second floating diffusion region FD₂. If the controller or image processor determines that there is a full charge in the first floating diffusion region FD₁, then the DCG transistor 234 is activated so that charge is stored in the capacitor 236. The pixel signal voltage Vsig associated with the remaining pixel signal charge stored in the first floating diffusion region FD₁ (as output by the source follower transistor 208 and activated row select transistor 209) is then sampled and held by the pixel signal sample and hold pixel signal SHS.

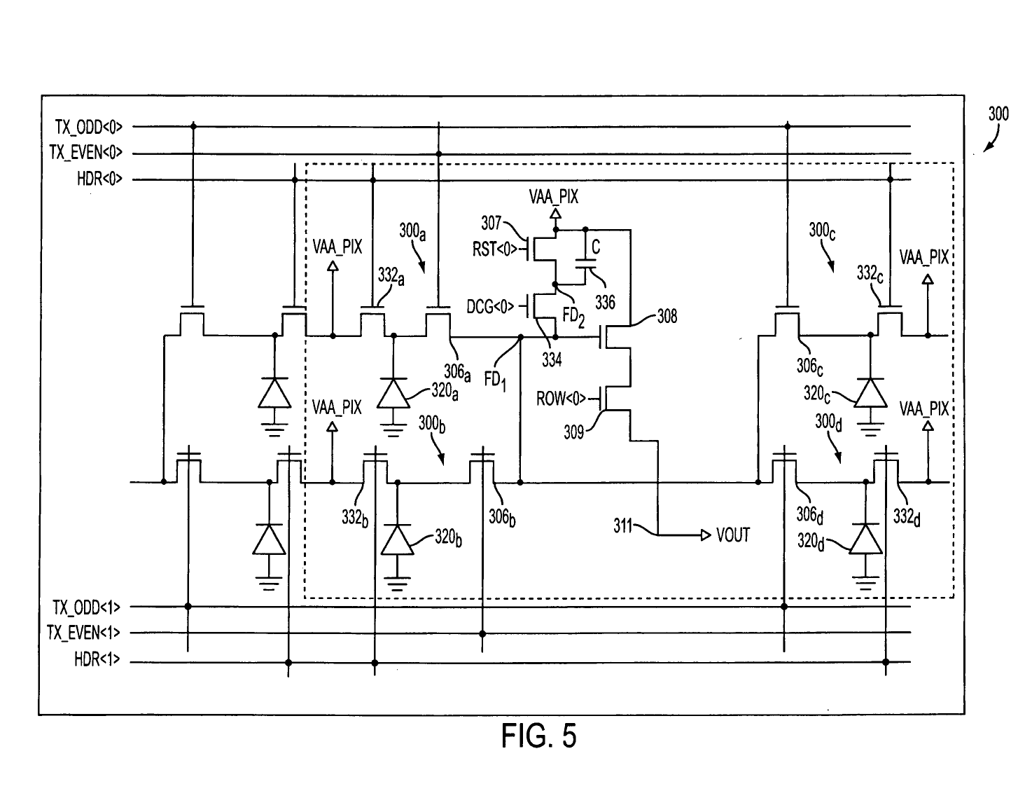

Although the pixel cell 200 has increased charge storage capability, it does not achieve a desirable increased fill factor since additional components are used in the cell 200 (e.g., DCG transistor 234 and capacitor 236). One way to increase fill factor is to share components between adjacent pixels. FIG. 5 illustrates an exemplary four-way shared CMOS imager pixel circuit 300 constructed in accordance with an embodiment of the invention. The pixel circuit 300 shares reset and readout circuitry among four pixel cells 300ₐ, 300_{b}, 300_{c}, 300_{d}. Specifically, the four pixel cells 300ₐ, 300_{b}, 300_{c}, 300_{d} share first and second floating diffusion regions FD₁, FD₂, a DCG transistor 334, reset transistor 307, storage capacitor 336, source follower transistor 308 and a row select transistor 309.

The first pixel cell 300ₐ includes a first photosensor 320ₐ (illustrated as a photodiode) and a first transfer transistor 306ₐ. A first high dynamic range (HDR) transistor 332ₐ may also be part of the pixel cell 300ₐ if desired. The first HDR transistor 332ₐ (if included) is connected between the first photosensor 320ₐ and the pixel supply voltage Vaa-pix. The gate terminal of the first HDR transistor 332ₐ is connected to receive a first high dynamic range control signal HDR<0>. In operation, when the first high dynamic range control signal HDR<0> is generated, the HDR transistor 332ₐ is activated, which allows charge to be drained away from the photosensor 320ₐ.

The first transfer transistor 306ₐ is connected between the first photosensor 320ₐ and the shared first floating diffusion region FD₁ and is controllable by a first even column transfer gate control signal TX_EVEN<0>. When the first even column transfer gate control signal TX_EVEN<0> is generated, the first transfer transistor 306ₐ is activated, which allows charge from the first photosensor 320ₐ to flow to the first floating diffusion region FD₁.

The second pixel cell 300_{b} includes a second photosensor 320_{b} (illustrated as a photodiode) and a second transfer transistor 306_{b}. A second HDR transistor 332_{b} may also be part of the second pixel cell 300_{b} if desired. The second HDR transistor 332_{b} (if included) is connected between the second photosensor 320_{b} and the pixel supply voltage Vaa-pix. The gate terminal of the second HDR transistor 332_{b} is connected to receive a second high dynamic range control signal HDR<1>. In operation, when the second high dynamic range control signal HDR<1> is generated, the second HDR transistor 332_{b} is activated, which allows charge to be drained away from the second photosensor 320_{b}.

The second transfer transistor 306_{b} is connected between the second photosensor 320_{b} and the shared first floating diffusion region FD₁ and is controllable by a second even column transfer gate control signal TX_EVEN<1>. When the second even column transfer gate control signal TX_EVEN<1> is generated, the second transfer transistor 306_{b} is activated, which allows charge from the second photosensor 320_{b} to flow to the first floating diffusion region FD₁.

The third pixel cell 300_{c} includes a third photosensor 320_{c} (illustrated as a photodiode) and a third transfer transistor 306_{c}. A third HDR transistor 332_{c} may also be part of the third pixel cell 300_{c} if desired. The third HDR transistor 332_{c} (if included) is connected between the third photosensor 320_{c} and the pixel supply voltage Vaa-pix. The gate terminal of the third HDR transistor 332_{c} is connected to receive the first high dynamic range control signal HDR<0>. In operation, when the first high dynamic range control signal HDR<0> is generated, the third HDR transistor 332_{c} is activated, which allows charge to be drained away from the third photosensor 320_{c}.

The third transfer transistor 306_{c} is connected between the third photosensor 32° C. and the shared first floating diffusion region FD₁ and is controllable by a first odd column transfer gate control signal TX_ODD<0>. When the first odd column transfer gate control signal TX_ODD<0> is generated, the third transfer transistor 306_{c} is activated, which allows charge from the third photosensor 320_{c} to flow to the first floating diffusion region FD₁.

The fourth pixel cell 300_{d} includes a fourth photosensor 320_{d} (illustrated as a photodiode) and a fourth transfer transistor 306_{d}. A fourth HDR transistor 332_{d} may also be part of the fourth pixel cell 300_{d} if desired. The fourth HDR transistor 332_{d} (if included) is connected between the fourth photosensor 320_{d} and the pixel supply voltage Vaa-pix. The gate terminal of the fourth HDR transistor 332_{d} is connected to receive a second high dynamic range control signal HDR<1>. In operation, when the second high dynamic range control signal HDR<1> is generated, the fourth HDR transistor 332_{d} is activated, which allows charge to be drained away from the fourth photosensor 320_{d}.

The fourth transfer transistor 306_{d} is connected between the fourth photosensor 320_{d} and the shared first floating diffusion region FD₁ and is controllable by a second odd column transfer gate control signal TX_ODD<1>. When the second odd column transfer gate control signal TX_ODD<1> is generated, the fourth transfer transistor 306_{d} is activated, which allows charge from the fourth photosensor 320_{d} to flow to the first floating diffusion region FD₁.

The gate of the source follower transistor 308 is connected to the first floating diffusion region FD₁. A source/drain terminal of the source follower transistor 308 is connected to the array pixel supply voltage Vaa-pix. The row select transistor 309 is connected between the source follower transistor 308 and a column line 311.

The reset transistor 307 is connected between the array pixel supply voltage Vaa-pix and the second floating diffusion region FD₂. The capacitor 336 is connected across the reset transistor 307. The DCG transistor 334 is connected between the first floating diffusion region FD₁ and the second floating diffusion region FD₂. The gate terminal of the DCG transistor 334 is connected to a dual conversion gain control signal DCG.

When the dual conversion gain control signal DCG is generated, the DCG transistor 334 is activated, which connects the storage capacitance C of the capacitor 336, and the second floating diffusion region FD₂, to the first floating diffusion region FD₁. This increases the storage capability of the pixel circuit 300 beyond the capacity of the first floating diffusion region FD₁, which is desirable and mitigates the leakage problems of the conventional pixel cell 100 (FIG. 1). That is, the pixel circuit 300 contains a first conversion gain based solely on the storage capacity of the first floating diffusion region FD₁, which is beneficial for low light conditions, and a second conversion gain based on the storage capacities of the first floating diffusion region FD₁ and the capacitor 336 (connected at the second floating diffusion region FD₂), which is beneficial for bright light conditions.

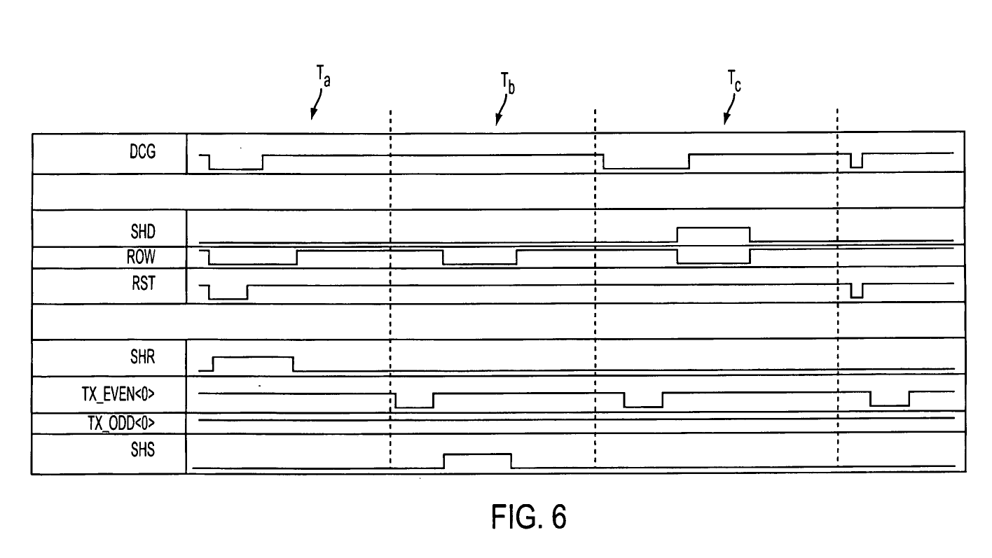

FIG. 6 is a timing diagram illustrating an exemplary operation of a portion of the pixel circuit 300 illustrated in FIG. 5. For clarity purposes only, the timing diagram illustrates the operation of the first pixel cell 300ₐ. It should be noted that the operation of the circuit 300 would repeat the following steps for the operation of the remaining pixels 300_{b}, 300_{c}, 300_{d}. Since the operation of the first row is essentially the same (with the below noted exceptions), a detailed description of the operation of the remaining pixels 300_{b}, 300_{c}, 300_{d} is not provided. FIG. 6 illustrates the row select signal ROW as being toggled high and low at certain instances. It should be appreciated that the row select signal ROW could remain applied during all three time periods Tₐ, T_{b}, T_{c} if desired.

The timing diagram illustrates three periods Tₐ, T_{b}, T_{c}. During the first time period Tₐ, the row select signal ROW is applied to the gate of the row select transistor 309 (shown as being active low in FIG. 6). It should be appreciated that FIG. 6 is an example timing diagram and that it is immaterial whether a signal is illustrated as being active low or high in FIG. 6. All that is required to practice the invention is for the illustrated signal to activate the component the signal is controlling.

The first floating diffusion region FD₁ of the pixel circuit 300 is reset by asserting the dual conversion gain control signal DCG (shown as being active low in FIG. 6) and the reset control signal RST (shown as being active low in FIG. 6) at the same time. This causes the array pixel supply voltage Vaa-pix to be applied to the first floating diffusion region FD₁ (through the reset and DCG transistors 307, 334). The array pixel supply voltage Vaa-pix is also applied to the second floating diffusion region FD₂. The reset signal voltage Vrst associated with the reset first floating diffusion region FD₁ (as output by the source follower transistor 308 and activated row select transistor 309) is applied to the column line 311 and then sampled and held by the sample and hold circuit 761 (FIG. 8), for the first pixel cell 300ₐ, by the pulsing of a sample and hold reset signal SHR.

During the second time period T_{b}, charge accumulating in the first photosensor 320ₐ is transferred to the first floating diffusion region FD₁ when the first even column transfer gate control signal TX_EVEN<0> is asserted (shown as being active low in FIG. 6) and activates the first transfer transistor 306ₐ. The pixel signal voltage Vsig1 associated with the first pixel cell's 300ₐ pixel signal charge stored in the first floating diffusion region FD₁ (as output by the source follower transistor 308 and activated row select transistor 309) is then sampled and held by the sample and hold circuit 761 (FIG. 8) by the pulsing of a sample and hold pixel signal SHS.

To increase the charge storage capacity of the pixel cell 300ₐ, the following operations are performed during the third time period T_{c}. It should be noted that the following third time period T_{c} operations may be performed for every readout operation or only when needed to avoid the over capacity condition described above (i.e., when a controller or image processor (described below in more detail with respect to FIG. 8) determines that the amount of incident light will result in the first floating diffusion region FD₁ being saturated).

During the third time period T_{c}, the dual conversion gain control signal DCG is applied (shown as being active low in FIG. 6). This causes the DCG transistor 334 to become active, which connects the first floating diffusion region FD₁ to the second floating diffusion region FD₂. The full charge within the first floating diffusion region FD₁ flows to the second floating diffusion region FD₂ and is stored in the capacitor 326. The first even column transfer gate control signal TX_EVEN<0> is applied (shown as being active low in FIG. 6) to activate the first transfer transistor 306ₐ. The remaining excess charge from the first photosensor 320ₐ is stored in the first floating diffusion region FD₁. The new pixel signal voltage Vsig2 associated with the excess pixel signal charge stored in the first floating diffusion region FD₁ (as output by the source follower transistor 308 and activated row select transistor 309) is applied to a column line 311 connected to a sample and hold circuitry 761 (FIG. 8) and then sampled and held by the pulsing of a third sample and hold pixel signal SHD. The three sampled and held signals Vrst, Vsig1, Vsig2 may then undergo a correlated sampling operation to obtain the actual pixel signal level for each conversion gain (e.g., Vrst-Vsig1, Vrst-Vsig2).

The operations are then repeated for the remaining pixels 300_{b}, 300_{c}, 300_{d}. It should be noted that for the remaining pixels 300_{b}, 300_{c}, 300_{d}, the same operations would occur except that the transfer gates 306_{b}, 306_{c}, 306_{d} are controlled by transfer gate control signals TX_EVEN<1>, TX_ODD<0>, TX_ODD<1>, respectively.

It should be noted that if HDR transistors 332ₐ, 332_{b}, 332_{c}, 332_{d} are used in the pixel circuit 300, then the high dynamic range control signals HDR<0>, HDR<1> would be applied throughout all three time periods Tₐ, T_{b}, T_{c} to ensure that the HDR transistors 332ₐ, 332_{b}, 332_{c}, 332_{d} remain active during the readout operations. This prevents blooming and other phenomena from occurring during the readout process by draining some charge away from the photosensors 320ₐ, 320_{b}, 320_{c}, 320_{d}.

It should also be noted that another way to operate the pixel 300 circuit is to transfer charge from the photosensors 320ₐ, 320_{b}, 320_{c}, 320_{d} to the first floating diffusion region FD₁ during the second time period T_{b}. Instead of reading out the charge immediately, the charge is allowed to stay, and if there is too much charge, the charge will leak to the second floating diffusion region FD₂. If the controller or image processor determines that there is a full charge in the first floating diffusion region FD₁, then the DCG transistor 334 is activated so that charge is stored in the capacitor 336. The pixel signal voltage Vsig associated with the remaining pixel signal charge stored in the first floating diffusion region FD₁ (as output by the source follower transistor 308 and activated row select transistor 309) is then sampled and held by the pixel signal sample and hold pixel signal SHS.

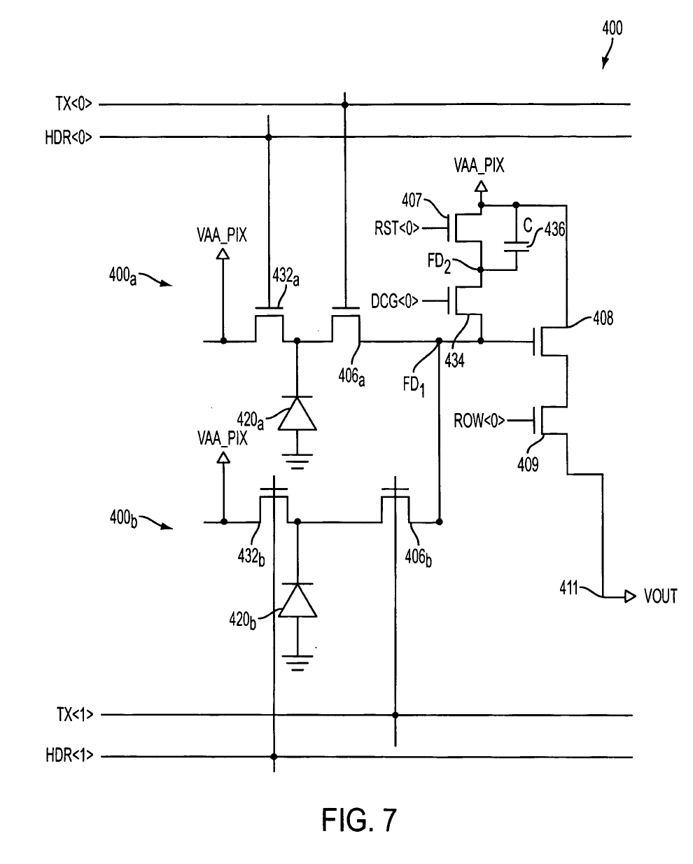

FIG. 7 illustrates an exemplary two-way shared CMOS imager pixel circuit 400 constructed in accordance with an embodiment of the invention. The pixel circuit 400 shares reset and readout circuitry between two pixel cells 400ₐ, 400_{b}. Specifically, the pixel cells 400ₐ, 400_{b} share first and second floating diffusion regions FD₁, FD₂, a DCG transistor 434, reset transistor 407, storage capacitor 436, source follower transistor 408 and a row select transistor 409.

The first pixel cell 400ₐ includes a first photosensor 420ₐ (illustrated as a photodiode) and a first transfer transistor 406ₐ. A first high dynamic range (HDR) transistor 432ₐ may also be part of the first pixel cell 400ₐ if desired. The first HDR transistor 432ₐ (if included) is connected between the first photosensor 420ₐ and the pixel supply voltage Vaa-pix. The gate terminal of the first HDR transistor 432ₐ is connected to receive a first high dynamic range control signal HDR<0>. In operation, when the first high dynamic range control signal HDR<0> is generated, the first HDR transistor 432ₐ is activated, which allows charge to be drained away from the first photosensor 420ₐ.

The first transfer transistor 406ₐ is connected between the first photosensor 420ₐ and the shared first floating diffusion region FD₁ and is controllable by a first transfer gate control signal TX<0>. When the first transfer gate control signal TX<0> is generated, the first transfer transistor 406ₐ is activated, which allows charge from the first photosensor 420ₐ to flow to the first floating diffusion region FD₁.

The second pixel cell 400_{b} includes a second photosensor 420_{b} (illustrated as a photodiode) and a second transfer transistor 406_{b}. A second HDR transistor 432_{b} may also be part of the second pixel cell 400_{b} if desired. The second HDR transistor 432_{b} (if included) is connected between the second photosensor 420_{b} and the pixel supply voltage Vaa-pix. The gate terminal of the second HDR transistor 432_{b} is connected to receive a second high dynamic range control signal HDR<1>. In operation, when the second high dynamic range control signal HDR<1> is generated, the second HDR transistor 432_{b} is activated, which allows charge to be drained away from the second photosensor 420_{b}.

The second transfer transistor 406_{b} is connected between the second photosensor 320_{b} and the shared first floating diffusion region FD₁ and is controllable by a second transfer gate control signal TX<1>. When the second transfer gate control signal TX<1> is generated, the second transfer transistor 406_{b} is activated, which allows charge from the second photosensor 420_{b} to flow to the first floating diffusion region FD₁.

The gate of the source follower transistor 408 is connected to the first floating diffusion region FD₁. A source/drain terminal of the source follower transistor 408 is connected to the array pixel supply voltage Vaa-pix. The row select transistor 409 is connected between the source follower transistor 408 and a column line 411.

The reset transistor 407 is connected between the array pixel supply voltage Vaa-pix and the second floating diffusion region FD₂. The capacitor 436 is connected across the reset transistor 407 and the second floating diffusion region FD₂. The DCG transistor 434 is connected between the first floating diffusion region FD₁ and the second floating diffusion region FD₂. The gate terminal of the DCG transistor 434 is connected to a dual conversion gain control signal DCG<0>.

When the dual conversion gain control signal DCG<0> is generated, the DCG transistor 434 is activated, which connects the storage capacitance C of the capacitor 436, and the second floating diffusion region FD₂, to the first floating diffusion region FD₁. This increases the storage capability of the pixel circuit 400 beyond the capacity of the first floating diffusion region FD₁, which is desirable and mitigates the leakage problems of the conventional pixel cell 100 (FIG. 1). That is, the pixel circuit 400 contains a first conversion gain based solely on the storage capacity of the first floating diffusion region FD₁, which is beneficial for low light conditions, and a second conversion gain based on the storage capacities of the first floating diffusion region FD₁ and the capacitor 436, which is beneficial for bright light conditions.

FIG. 8 illustrates an exemplary imager 700 that may utilize any of the embodiments of the invention. The Imager 700 has a pixel array 705 comprising pixels constructed and operated as described above with respect to FIGS. 3-7. Row lines are selectively activated by a row driver 710 in response to row address decoder 720. A column driver 760 and column address decoder 770 are also included in the imager 700. The imager 700 is operated by the timing and control circuit 750, which controls the address decoders 720, 770. The control circuit 750 also controls the row and column driver circuitry 710, 760 in accordance with an embodiment of the invention (e.g., FIGS. 4 and 6).

A sample and hold circuit 761 associated with the column driver 760 reads the pixel reset signal Vrst and the two pixel image signals Vsig1, Vsig2 for the selected pixel which may then undergo a correlated sampling operation to obtain the actual pixel signal level (e.g., Vrst-Vsig1, Vrst-Vsig2). The correlated signals are amplified by amplifier 762 for each pixel and are digitized by analog-to-digital converter 775 (ADC). The analog-to-digital converter 775 supplies the digitized pixel signals to an image processor 780 which forms a digital image. Both of the signals may be converted to digital signals and sent to the image processor 780, or only one of the two signal may be selected for conversion and sent to the image processor 780.

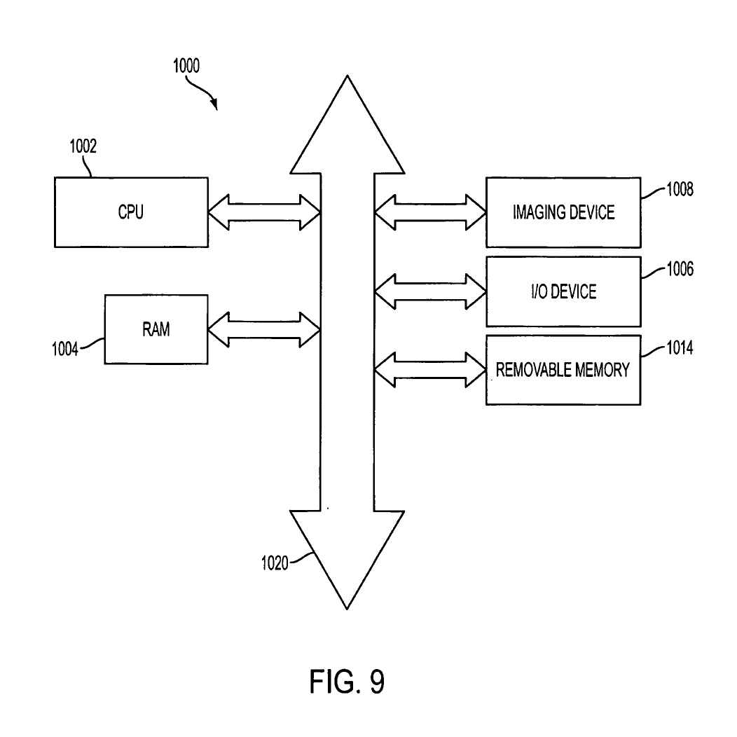

FIG. 9 shows a system 1000, a typical processor system modified to include an imaging device 1008 (such as the imaging device 700 illustrated in FIG. 8) of the invention. The processor system 1000 is exemplary of a system having digital circuits that could include image sensor devices. Without being limiting, such a system could include a computer system, camera system, scanner, machine vision, vehicle navigation, video phone, surveillance system, auto focus system, star tracker system, motion detection system, image stabilization system, and data compression system, and other systems employing an imager.

System 1000, for example a camera system, generally comprises a central processing unit (CPU) 1002, such as a microprocessor, that communicates with an input/output (I/O) device 1006 over a bus 1020. Imaging device 1008 also communicates with the CPU 1002 over the bus 1020. The processor-based system 1000 also includes random access memory (RAM) 1004, and can include removable memory 1014, such as flash memory, which also communicate with the CPU 1002 over the bus 1020. The imaging device 1008 may be combined with a processor, such as a CPU, digital signal processor, or microprocessor, with or without memory storage on a single integrated circuit or on a different chip than the processor.

It should be noted that the invention has been described with reference to photodiode photosensors, but it should be appreciated that the invention may be utilized with any type of photosensor used in an imaging pixel circuit such as, but not limited to, photogates, photoconductors, photodiodes and pinned photodiodes and various configurations of photodiodes and pinned photodiodes.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

What is claimed as new and desired to be protected by Letters Patent of the United States is:

1. A method of operating an imager device comprising:
resetting a first diffusion region through a second diffusion region;
outputting a first signal representing the reset first diffusion region;
storing photo-generated charge in the first diffusion region; and
outputting a second signal representing the stored photo-generated charge.

2. The method of claim 1, further comprising the acts of:
transferring the stored photo-generated charge to the second diffusion region;
storing additional photo-generated charge in the first diffusion region; and
outputting a third signal representing the stored additional photo-generated charge.

3. The method of claim 2, further comprising the acts of:
sampling and holding the first, second and third signals; and
using the sampled and held first, second and third signals to obtain a correlated output value.

4. The method of claim 2, wherein the act of transferring the stored photo-generated charge to the second diffusion region further comprises:
activating a dual conversion gain element; and storing the transferred stored photo-generated charge in a storage element.

5. The method of claim 2, wherein the act of transferring the stored photo-generated charge to the second diffusion region further comprises:
determining if the stored photo-generated charge exceeds a predetermined level; and
if the stored photo-generated charge exceeds the predetermined level, activating a dual conversion gain element and storing the transferred stored photo-generated charge in a storage element.

6. The method of claim 2, wherein said act of storing photo-generated charge comprises the act of transferring the charge from a photosensitive element to the first diffusion region via a transfer element.

7. The method of claim 6, wherein said act of storing additional photo-generated charge comprises the act of transferring the additional photo-generated charge from the photosensitive element to the first diffusion region via the transfer element.

8. The method of claim 6, further comprising the act of draining excess charge away from the photosensitive device.

9. A method of operating an imager device comprising an array of shared pixel cells, said method comprising the acts of:
resetting a first shared diffusion region through a dual conversion gain element connected to a second shared diffusion region;
outputting a first signal representing the reset first shared diffusion region;
storing first photo-generated charge from a first pixel cell in the first shared diffusion region;
outputting a second signal representing the stored first photo-generated charge;
transferring the stored first photo-generated charge to the second shared diffusion region;
storing additional first photo-generated charge in the first shared diffusion region; and
outputting a third signal representing the stored additional first photo-generated charge.

10. The method of claim 9, further comprising the acts of:
storing second photo-generated charge from a second pixel cell in the first shared diffusion region;
outputting a fourth signal representing the stored second photo-generated charge;
transferring the stored second photo-generated charge to the second shared diffusion region;
storing additional second photo-generated charge in the first diffusion region; and
outputting a fifth signal representing the stored additional second photo-generated charge.

11. The method of claim 10, further comprising the acts of:
sampling and holding the first, second and third signals; and
using the sampled and held first, second and third signals to obtain a correlated output value.

12. The method of claim 10, further comprising the acts of:
sampling and holding the first, second, third, fourth and fifth signals;
using the sampled and held first, second and third signals to obtain a first correlated output value; and
using the sampled and held first, fourth and fifth signals to obtain a second correlated output value.

13. The method of claim 10, further comprising the act of repeating said resetting the first shared diffusion region step to said outputting a fifth signal step for a subsequent row of shared pixels.

14. The method of claim 9, wherein the act of transferring the stored first photo-generated charge to the second diffusion region further comprises:
activating the dual conversion gain element; and
storing the transferred stored first photo-generated charge in a storage element.

15. The method of claim 9, wherein the act of transferring the stored first photo-generated charge to the second diffusion region further comprises:
determining if the stored first photo-generated charge exceeds a predetermined level; and
if the stored photo-generated charge exceeds the predetermined level, activating the dual conversion gain element and storing the transferred stored first photo-generated charge in a storage element.

16. The method of claim 15, further comprising the act of draining excess charge away from the photosensitive device of the first pixel.

17. A method of operating an imager device comprising:
resetting a first diffusion region through a dual conversion gain element;
outputting a first signal representing the reset first diffusion region;
storing photo-generated charge in the first diffusion region;
allowing stored photo-generated charge to leak to a second diffusion region;
storing additional photo-generated charge in the first diffusion region; and
outputting a second signal representing the stored additional photo-generated charge.

18. The method of claim 17, further comprising the acts of:
sampling and holding the first and second signals; and
using the sampled and held first and second signals to obtain a correlated output value.

19. The method of claim 17, further comprising the act of draining excess charge away from a photosensitive device.

20. The method of claim 17,further comprising the act of:
activating the dual conversion gain element; and
storing the leaked photo-generated charge in a storage element.

21. The method of claim 17, wherein said act of storing photo-generated charge comprises the act of transferring the charge from a photosensitive element to the first diffusion region via a transfer element.

22. The method of claim 21, wherein said act of storing additional photo-generated charge comprises the act of transferring the additional photo-generated charge from the photosensitive element to the first diffusion region via the transfer element.

23. An imaging device comprising:
a first photosensitive element;
a first transfer transistor coupled between the first photosensitive element and a first diffusion region, said first transfer transistor transferring photo-generated charge from the first photosensitive element to said first diffusion region;
a dual conversion gain element coupled between the first diffusion region and a second diffusion region, said dual conversion gain element connecting said first diffusion region to the second diffusion region when activated;
a reset element coupled between a reset voltage and the second diffusion region; and
a charge storage element coupled across the reset element,
wherein said first diffusion region is reset by activating said reset and dual conversion gain elements.

24. The imaging device of claim 23, wherein said reset and dual conversion gain elements comprise transistors.

25. The imaging device of claim 23, further comprising a high dynamic range element coupled between a voltage source and the first photosensitive element.

26. The imaging device of claim 25, wherein said high dynamic range element is activated to drain charge from the first photosensitive element.

27. The imaging device of claim 23, further comprising:
a second photosensitive element; and
a second transfer transistor coupled between the second photosensitive element and said first diffusion region.

28. The imaging device of claim 23, further comprising:
a second photosensitive element;
a second transfer transistor coupled between the second photosensitive element and said first diffusion region;
a third photosensitive element;
a third transfer transistor coupled between the third photosensitive element and said first diffusion region;
a fourth photosensitive element; and a fourth transfer transistor coupled between the fourth photosensitive element and said first diffusion region.

29. The imaging device of claim 23, wherein said charge storage element is a capacitor that increases the conversion gain of the first diffusion region when the dual conversion gain element is activated.

30. The imaging device of claim 23, wherein said charge storage element is a capacitor that stores charge from the first diffusion region when the dual conversion gain element is activated.

31. An imager system comprising:
a processor; and
an imaging device connected to said processor, said imaging device comprising:
a first photosensitive element,
a first transfer transistor coupled between the first photosensitive element and a first diffusion region, said first transfer transistor transferring photo-generated charge from the first photosensitive element to said first diffusion region,
a dual conversion gain element coupled between the first diffusion region and a second diffusion region, said dual conversion gain element connecting said first diffusion region to the second diffusion region when activated,
a reset element coupled between a reset voltage and the second diffusion region, and
a charge storage element coupled across the reset element;
wherein said first diffusion region is reset by activating said reset and dual conversion gain elements.

32. The system of claim 31, wherein said reset and dual conversion gain elements comprise transistors.

33. The system of claim 31, wherein said imaging device further comprises a high dynamic range element coupled between a voltage source and the first photosensitive element.

34. The system of claim 33, wherein said high dynamic range element is activated to drain charge from the first photosensitive element.

35. The system of claim 31, wherein said imaging device further comprises:
a second photosensitive element; and
a second transfer transistor coupled between the second photosensitive element and said first diffusion region.

36. The system of claim 31, wherein said imaging device further comprises:
a second photosensitive element;
a second transfer transistor coupled between the second photosensitive element and said first diffusion region;
a third photosensitive element;
a third transfer transistor coupled between the third photosensitive element and said first diffusion region;
a fourth photosensitive element; and
a fourth transfer transistor coupled between the fourth photosensitive element and said first diffusion region.

37. The system of claim 31, wherein said charge storage element is a capacitor that increases the conversion gain of the first diffusion region when the dual conversion gain element is activated.

38. The system of claim 37, wherein said charge storage element is a capacitor that stores charge from the first diffusion region when the dual conversion gain element is activated.
